(19) United States
(12) Patent Application Publication
(10) Pub. No.: US 2022/0234455 A1
(43) Pub. Date: Jul. 28, 2022

(54) HIGH-CURRENT MODULE FOR CHARGING PLUG-IN CONNECTOR PART

(71) Applicant: PHOENIX CONTACT E-Mobility GmbH, Schieder-Schwalenberg (DE)

(72) Inventors: Thomas Fuehrer, Blomberg (DE); Lucas Funk, Detmold (DE)

(21) Appl. No.: 17/578,500

(22) Filed: Jan. 19, 2022

(30) Foreign Application Priority Data
Jan. 25, 2021 (DE) 10 2021 101 528.6

(51) Int. Cl. B60L 53/16; B60L 53/302

(52) U.S. Cl. CPC B60L 53/16; B60L 53/18; B60L 53/302

(57) ABSTRACT

A module for a plug-in connector part includes: a sleeve; at least two busbars, arranged in the sleeve, to each of which a plug contact and at least one load line are connectable or connected; and at least one heat capacity element mounted in or on the sleeve. The module is mountable on the plug-in connector part.

### CROSS-REFERENCE TO PRIOR APPLICATION

Priority is claimed to German Patent Application No. DE 10 2021 101 528.6, filed on Jan. 25, 2021, the entire disclosure of which is hereby incorporated by reference herein.

### FIELD

The invention relates to a module for a plug-in connector part, a plug-in connector part, and a method for producing such a plug-in connector part.

### BACKGROUND

Particularly in the field of e-mobility, the highest demands with respect to the current-carrying capacity and the associated thermal loads exist for plug-in connector parts and associated cable assemblies. In addition to the cables, the plug-in connectors are regularly exposed to high charging currents—for example, of several hundred amperes. These high currents are supposed to be transmitted with the lowest possible power loss. Even higher currents are being considered for the future. Against this background, it is worth noting that the power loss rises as the square of the current. This regularly results in the problem of designing components which provide as good an electrical performance as possible with a manageable overall size. In the case of electromechanical connections, this typically means as small an electrical resistance as possible, with simultaneously controlled heating.

This has often been successfully achieved with actively-cooled plug connectors and charging cables. However, the technical effort that is usually required for this is reflected in the costs and the effort for the production of the actively-cooled components of the corresponding charging devices.

To date, there have been no suitable solutions—particularly in a charging current range in which active cooling is not yet economical, but a conventional construction with crimped contacts potentially heats up too quickly, e.g., in a range around 300 A.

DE 10 2016 107 409 A1 proposes a plug-in connector part with active cooling. DE 10 2016 105 308 A1 describes a vehicle charging socket with thermal capacity elements.

### SUMMARY

In an embodiment, the present invention provides a module for a plug-in connector part, comprising: a sleeve; at least two busbars, arranged in the sleeve, to each of which a plug contact and at least one load line are connectable or connected; and at least one heat capacity element mounted in or on the sleeve, wherein the module is mountable on the plug-in connector part.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a view of a vehicle with a plug-in connector part, designed as a vehicle charging plug, which is connected to a charging station via a cable;

FIGS. 2 and 3 are views of the plug-in connector part, designed as a vehicle charging plug, according to FIG. 1;

FIGS. 4 and 5 show parts of the connector part according to FIGS. 2 and 3;

FIG. 6 is a view of a module of the plug-in connector part of FIGS. 2 and 3;

FIGS. 7 through 9 show parts of the plug-in connector part according to FIGS. 2 and 3 in exploded views;

FIGS. 10 and 11 are cross-sectional views of the connector part according to FIG. 6; and

FIGS. 12 and 13 are views of parts of the module according to FIG. 6;

FIGS. 14 and 15 are cross-sectional views of the module according to FIG. 6 mounted on parts of the plug-in connector part according to FIGS. 2 and 3; and

FIGS. 16 and 17 are views of the module according to FIG. 6.

### DETAILED DESCRIPTION

In an embodiment, the present invention provides a plug-in connector part which allows the lowest possible power loss and is particularly easy to produce.

Accordingly, a module for a plug-in connector part is specified, having a sleeve, at least two busbars, arranged in the sleeve, to each of which a plug contact and at least one load line can be connected or are connected, and at least one heat capacity element mounted in or on the sleeve. The (in particular, pre-assembled) module can be mounted on—in particular, in—the plug-in connector part.

In this way, a module, e.g., a pre-mounted and pre-testable module, is provided which can be installed in a particularly easy manner in the plug-in connector part and thus considerably simplify the production. The busbars can be designed with a particularly large cross-section and can thus significantly reduce the power loss. The heat capacity element enables the temperature rise to be delayed. The combination of the busbars with the heat capacity element and the installation in the module make it possible, in a particularly simple and easily producible structure, to limit the temperature rise to sufficiently low values over a typical charging period for charging the battery of an electric vehicle. The heat capacity element or the heat capacity elements is/are configured to absorb heat from the busbars. The heat capacity element(s) has/have a large thermal capacity and is/are thermally connected to one or both busbars so that heat can be introduced from the busbar(s) into the respective heat capacity element and absorbed there. This is based upon the idea of providing an increased heat capacity on a plug-in connector part, on the basis of which the heating of the plug-in connector part can be slowed down.

The connector part may be a high-current and/or high-voltage connector part. The module is in particular a high-current module. For example, the plug-in connector part is designed to conduct electrical currents of approximately 300 A or at least 300 A and/or have a power of approximately 135 kW or more than 135 kW.

For example, the at least one heat capacity element is produced from a material having a high specific heat capacity—for example, a specific heat capacity greater than 0.5 kJ/(kg*K), and in particular greater than 1.0 kJ/(kg*K). Alternatively or additionally, the material has a high thermal conductivity—for example above 50 W/(m*K), and in particular above 100 W/(m*K). This allows the heat to be efficiently conducted away from the busbars.

Optionally, the at least one heat capacity element is mounted on one of the busbars by means of a housing part—for example, made of an insulation material. As a result, electrical insulation of both parts with respect to other components and a fastening to one another is simultaneously made possible.

For example, the at least one heat capacity element lies flat against one of the busbars. This enables good heat transfer. The at least one heat capacity element can be in contact with the busbar—alternatively, with the interposition of an—in particular, planar—insulator. For example, the busbars and/or the heat capacity element(s) have a rectangular cross-section, at least in sections. Plane surfaces of the at least one heat capacity element and of the busbar(s) that are parallel to one another can thereby rest against one another.

In one embodiment, at least two heat capacity elements are provided. Optionally, the at least two busbars are arranged between the two heat capacity elements. This enables a particularly efficient absorption of heat.

For example, the module comprises at least one interface for mounting the pre-assembled module on the plug-in connector part. The interface is formed, for example, by a mounting adapter which, in one embodiment, closes an opening of the sleeve and, optionally, has an opening for each of the plug contacts. The mounting adapter can thus be mounted on a part—for example, a housing part—of the plug-in connector.

The busbars are mounted, for example, on an insulating support arranged in the sleeve. This enables further simplified production, since the insulating support with electrical insulation of the busbars from one another and the holder thereof fulfills a dual function. The insulating support has, for example, at least in sections, an H-shaped cross-section.

It can be provided that each of the busbars have a larger cross-section than one of the load lines connected or connectable thereto, or a cross-section greater than the sum of the cross-sections of several connected or connectable load lines—in particular, at least a cross-section that is twice as large (as the load line or load lines).

The at least two busbars can each have two sections which are at an angle to one another. Thus, the busbars can extend through an ergonomically-shaped plug-in connector part—in particular, in the form of a charging plug.

The sleeve can form an interior space, wherein the interior space is sealed—in particular, against water and/or dust. It is thus made possible for the module to be secured in its own right at least in sections against environmental influences and/or with respect to other lines or other components of the plug-in connector part.

According to one aspect, a plug-in connector part is provided for connecting to a mating connector part. The plug-in connector part comprises a housing and at least one module, arranged in the housing, according to any embodiment described herein.

The plug-in connector part may in particular be designed as a charging plug-in connector part—in particular, as a vehicle charging plug.

According to one aspect, a method for producing a plug-in connector part for connecting to a mating connector part is provided—in particular, the plug-in connector part according to any embodiment described herein. The method comprises assembling at least two busbars and at least one heat capacity element to form a pre-assembled module; and mounting the module in a housing of the plug-in connector part.

The idea forming the basis of the invention shall be explained in more detail below on the basis of the exemplary embodiment shown in the figures. The following are shown:

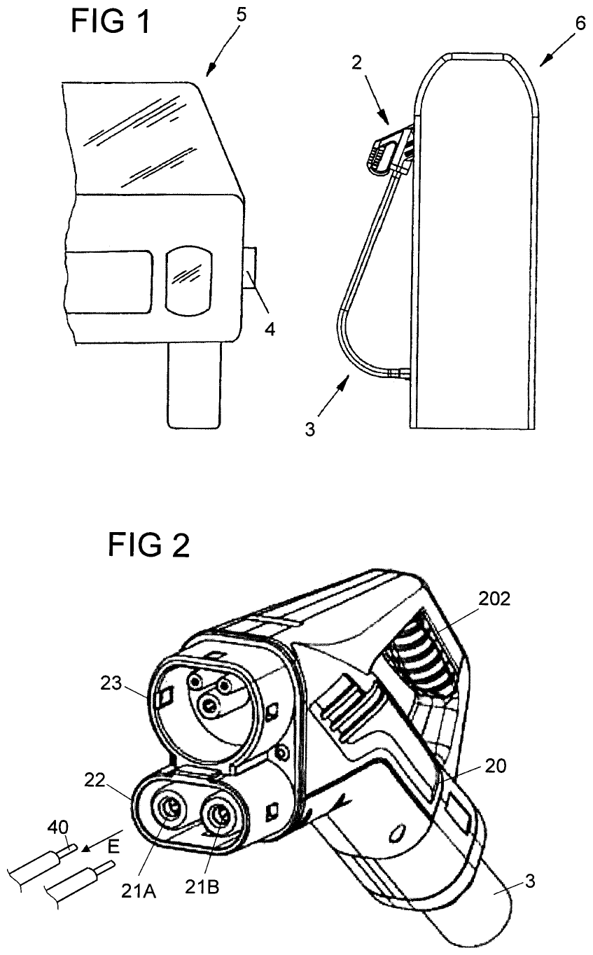

FIG. 1 shows an electrically-powered vehicle 5, also referred to as an electric vehicle, and a charging station 6, which serves to charge the vehicle 5. For this purpose, a plug-in connector part 2 in the form of a manually-pluggable vehicle charging plug is provided for detachable electrical connection to a mating connector part 4 in the form of a vehicle charging socket. Together, the plug-in connector part 2 and the mating connector part 4 form a plug connection. The charging station 6 is designed to provide a charging current in the form of a direct current (alternatively or additionally, an alternating current). The charging station 6 can be electrically connected to the vehicle 5 via a cable 3, which is connected at one end to the charging station 6 and at another end to the plug-in connector part 2. Optionally, the cable 3 has a plug-in connector part 2 at each of the two ends, of which one can be detachably connected to the mating connector part 4 on the vehicle 5 and another to a corresponding mating connector part at the charging station 6.

As can be seen from the enlarged view in FIG. 2, the plug-in connector part 2 has plug-in sections 22, 23, by means of which the plug-in connector part 2 can be brought into plug-in engagement with the associated mating connector part 4 in order to transmit charging currents from the charging station 6 to the vehicle 5.

The plug-in connector part 2 has a plurality of contact elements on its plug-in sections 22, 23. For example, two plug contacts 21A, 21B for transmitting the charging current in the form of a direct current can be arranged on the plug-in section 22, while, for example, three or five contact elements for providing load contacts are provided on the plug-in section 23 in order to transmit an (e.g., multi-phase) alternating current and/or to provide contacts for data transmission. In the specific exemplary embodiment shown in FIG. 2 of a plug-in connector part 2, the plug contacts 21A, 21B are arranged on a lower plug-in section 22 within two contact domes, said plug contacts being used for transmitting a charging current in the form of a direct current.

As shown schematically in FIG. 2, the plug-in contacts 21A, 21B on the plug-in section 22 of the plug-in connector part 2 can be brought into plug-in engagement with counter-contact elements 40 in the form of contact pins on sides of the mating connector part 4 in an insertion direction E in order to electrically contact the plug contacts 21A, 21B with the counter-contact elements 40.

The plug-in connector part 2 further comprises a housing 20, which forms a handle 202. A user can grip the plug-in connector part 2 on the handle 202 and attach said plug-in connector part to the mating connector part 4 or pull it off

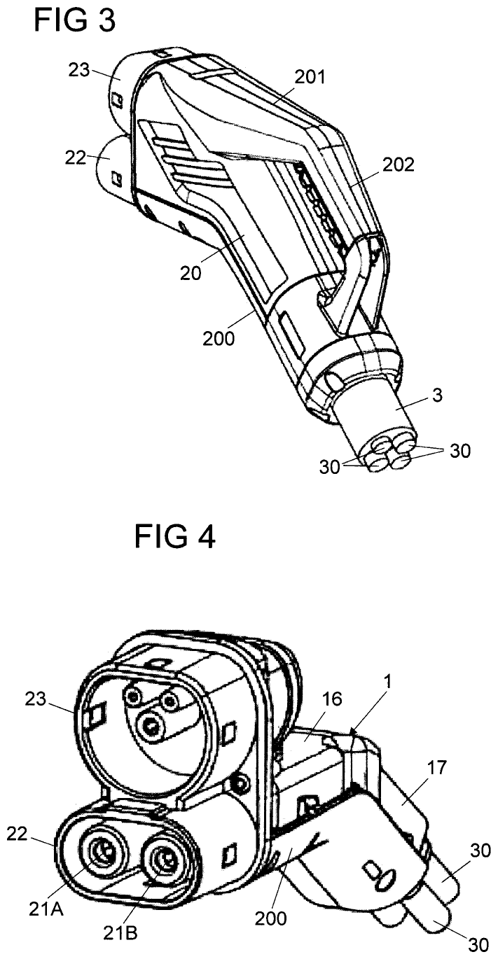

Load lines 30, which serve for transmitting a charging current through the plug-in connector part 2, are guided in the cable 3 connected to the plug-in connector part 2, as can be seen, for example, from FIG. 3.

In order to enable a rapid charging of the electric vehicle 5, e.g., in the context of a so-called rapid-charging process, the transmittable charging currents have a high amperage—for example, an amperage on the order of magnitude of 300 A or higher. Such high charging currents can generally lead to thermal losses on a plug-in connector part and, consequently, to a heating of the plug-in connector part.

The plug-in connector part 2 is not actively cooled. In particular, it has no channels for liquid cooling. In order to significantly slow down the heating of the plug-in connector part 2, the plug-in connector part 2 in the present case comprises a high-current module, which is referred to below as module 1 for short and will be described in detail below. The module 1 is a self-contained structural unit and can be installed pre-assembled in the housing 20 of the plug-in connector part 2. Before being installed in the housing 20 of the plug-in connector part 2, the module 1 can be pre-checked for correct function.

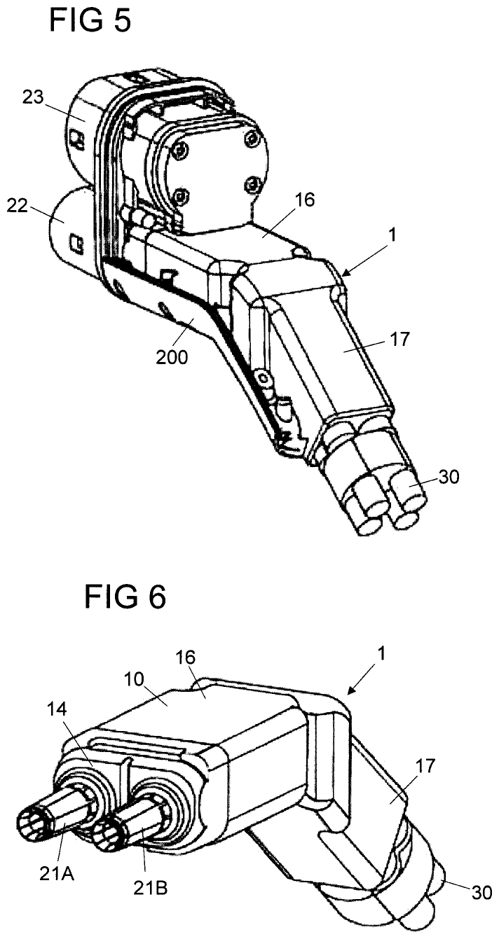

FIGS. 4 and 5 show the plug-in connector part 2, wherein an upper housing part 201 forming the handle 202 (see FIGS. 2 and 3) is removed from a lower housing part 200 so that an interior of the plug-in connector part 2 is visible. FIG. 6 shows the module 1 separately, together with the plug contacts 21A, 21B connected thereto (screwed with screw connections of module 1) and load lines 30. Optionally, the module 1 (in particular, at least for plug contacts 21A, 21B mounted thereon) is closed in a liquid-tight manner so that no liquid can penetrate into the module 1.

The module 1 comprises a first section 16 and a second section 17. The plug contacts 21A, 21B are mounted on the first section 16. The load lines 30 are connected to the second section 17. The first section 16 and the second section 17 run at an angle to one another. In the present case, the first section 16 is at an obtuse angle to the second section 17. In the assembled state of the plug-in connector part 2, the module 1 is arranged completely, or at least almost completely, in the interior of the housing 20.

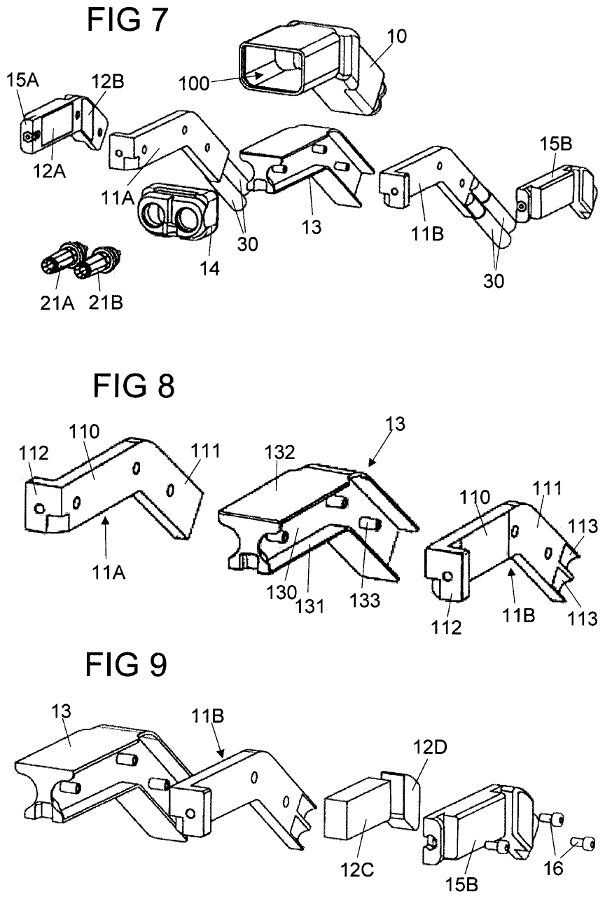

FIGS. 7-9 show the individual parts of the module 1. The module 1 comprises a sleeve 10. The sleeve 10 is flexible (e.g., made of rubber) or rigid. The sleeve 10 defines an interior space 100. The interior space 100 is accessible at two ends of the sleeve 10 facing away from one another. In the example shown, the sleeve 10 is formed in one piece.

The module 1 further comprises two busbars 11A, 11B and several (in the present case, four) heat capacity elements 12A-12D. The busbars 11A, 11B have a large cross-section—in particular, a substantially larger cross-section than the load line 30 connected in each case thereto—or, as in the example shown, in the case of several load lines 30 (in the present case, two) each connected to a busbar 11A, 11B, a larger or substantially larger cross-section than the sum of the cross-sections of the load lines 30 connected thereto. By using the busbars 11A, 11B, a particularly low electrical resistance can be achieved.

The busbars 11A, 11B each have a first section 110 and a second section 111. The first section 110 and the second section 111 are in each case extended longitudinally and, like the two sections 16, 17 of the module 1, are, as a whole, at an angle to each other. The first section 110 is adjoined by a mounting section 112 (at the end of the first section 110 facing away from the second section 111). A threaded bore is provided on the mounting section 112, on which one of the plug contacts 21A, 21B can be mounted in each case.

Receptacles 113 for the load lines 30 are formed on the second section 111 (in the present case, at the end of the second section 111 facing away from the first section 110); see, in particular, FIGS. 8 and 9. In the present example, these receptacles 113 are formed in the shape of a trough—in particular, for soldering the load lines 30—wherein, alternatively, flat receptacles are also conceivable—for example, for ultrasonic welding of the load lines 30. Each busbar 11A, 11B comprises two such trough-shaped receptacles 113. A load line 30 can be connected—in particular, connected by material bonding—to each of the receptacles 113. In the present case, in the method for producing the module 1 and the plug-in connector part 2, the load lines 30 are each inserted into the corresponding receptacles 113 and thus welded—for example, by means of ultrasonic welding.

The busbars 11A, 11B each have a rectangular cross-section. The busbars 11A, 11B are each formed in one piece—in particular, also of the same material. For example, the busbars 11A, 11B are made of copper. Optionally, the busbars 11A, 11B are punched and bent for production.

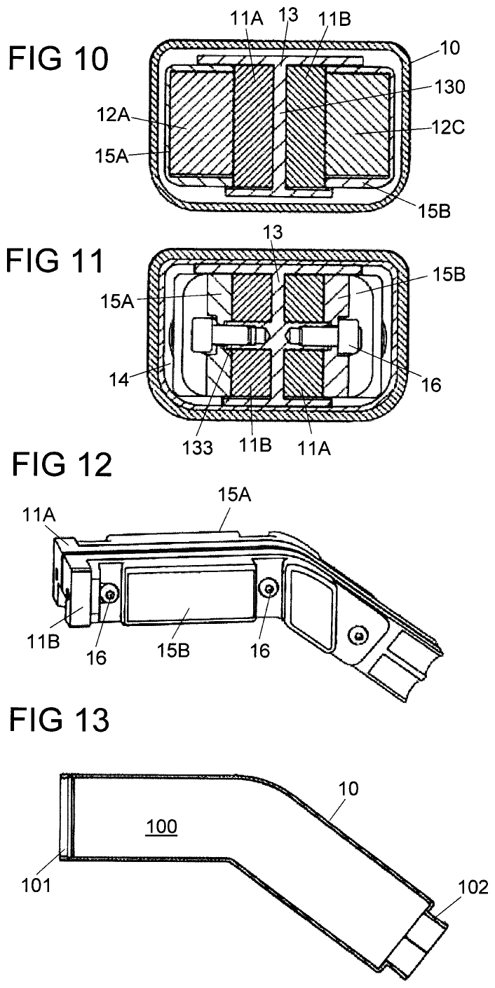

The heat capacity elements 12A-12D are produced, for example, from a material having a specific heat capacity of above 0.5 kJ/(kg*K), and in particular above 1.0 kJ/(kg*K). Furthermore, the material has a high thermal conductivity, e.g., above 50 W/(m*K), and in particular above 100 W/(m*K). The heat capacity elements 12A-12D are formed in a block shape. Each of the heat capacity elements 12A-12D is formed in one piece. In the assembled state (see, in particular, FIG. 10), the heat capacity elements 12A-12D each lie flat against one of the busbars 11A, 11B. The heat capacity elements 12A-12D are thermally coupled to the busbars 11A, 11B. Optionally, the heat capacity elements 12A-12D are electrically insulated from the busbars 11A, 11B—for example, by intermediate layer of an insulator. The heat capacity elements 12A-12D can, in total, have a weight which, for example, corresponds to at least 10%—in particular, at least 50%—of the sum of the weights of the busbars 11A, 11B. As a result, a substantial slowing of the heating of the busbars 11A, 11B and of the plug-in connector part 2 is possible. The heat capacity elements 12A-12D of the plug-in connector part 2 can be dimensioned such that, during a typical charging process, the heating remains below a predetermined limit—for example, below 50 K.

In the assembled state, the busbars 11A, 11B are electrically insulated from one another by an insulating support 13. For this purpose, the insulating support 13 comprises a separating section 130, which is arranged between the two busbars 11A, 11B in the assembled state. As can be seen in particular with reference to FIG. 10, the separating section 130 is in planar contact with each of the two busbars 11A, 11B. The insulating support 13 also serves to hold the two busbars 11A, 11B and the heat capacity elements 12A-12D. For this purpose, the insulating support 13 has several screw domes 133 on the separating section 130. The busbars 11A, 11B have matching holes with which the busbars 11A, 11B can be fitted onto the screw domes 133 (and are in the assembled state). In this case, the heat capacity elements 12A-12D are inserted into receptacles of housing parts 15A, 15B and are attached to the busbars 11A, 11B by means of said housing parts 15A, 15B. Screws 16 engage through bores in the housing parts 15A, 15B and will be or are screwed to the screw domes 133 (see, in particular, FIGS. 9 and 11). In the assembled state, a heat capacity element 12A, 12C in each case lies on the first section 110 of one of the busbars 11A, 11B, and a heat capacity element 12B, 12D in each case lies on the second section of one of the busbars 11A, 11B. The housing parts 15A, 15B are made from an electrically-insulating material.

The insulating support 13 further comprises two transverse parts 131, 132. The transverse parts 131, 132 each protrude at right angles from the separating section 130. In cross-section, the transverse parts 131, 132 and the separating section 130 are arranged as an H-shape; see, for example, FIG. 10. The two transverse parts 131, 132 extend in parallel to one another. It can be seen from FIG. 10 that the busbars 11A, 11B are arranged between two, opposite (and identical or mirror-inverted in design) heat capacity elements 12A-12B. The housing parts 15A, 15B and the insulating support 13 surround the busbars 11A, 11B and the heat capacity elements 12A-12D in an electrically-insulating manner. It can be seen from FIG. 11 how the housing parts 15A, 15B are screwed to the screw domes 133 of the insulating support 13 by means of the screws 16.

During assembly, for example, the busbars 11A, 11B and the heat capacity elements 12A-12D are first mounted on the insulating support 13—in the present case, screwed thereto—by means of the housing parts 15A, 15B, forming a mounted assembly. The mounted assembly is shown in FIG. 12, wherein the insulating support 13 only is not shown. FIG. 13 shows a cross-sectional view of the sleeve 10 with the interior space 100, which is accessible at one end via an opening 101, and at the other end via a feedthrough section 102 for the load lines 30. The mounted assembly is then arranged in the sleeve 10, e.g., inserted through the opening 101—optionally, with the already-connected load lines 30. Alternatively, a sleeve, which is initially open, is placed around the mounted assembly and then closed. If the module 1 is fully assembled and the load lines 30 are connected thereto, the load lines 30 extend through the feedthrough section 102—optionally, in a fluid-tight manner. Optionally, the feedthrough section 102 comprises a suitable passage opening for each load line 30.

In the pre-assembled module 1, the two busbars 11A, 11B and the heat capacity elements 12A-12D are thus arranged in the sleeve 10.

Furthermore, the module 1 comprises a mounting adapter 14; see, in particular, FIGS. 6 and 7. The mounting adapter 14 has two holes—in each case, one for one of the plug contacts 21A, 21B. In the assembled state of the module 1, the mounting adapter 14 is mounted on the opening 101 of the sleeve 10—optionally, with a fluid-tight connection—e.g., plugged thereon. The module 1 can be self-contained and also sealed.

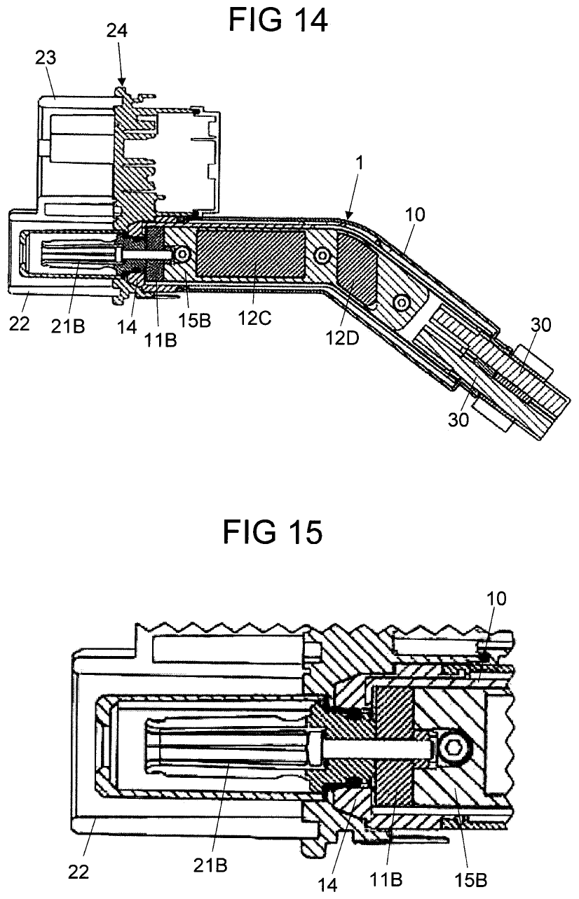

FIG. 14 shows the module 1 with the load lines 30 connected thereto, wherein it is also already mounted on a part of the plug-in connector part 2—in the present case, on a connector face part 24 of the plug-in connector part 2, which forms the plug sections 22, 23. For this purpose, the module 1 with the mounting adapter 14 is connected to the part of the plug-in connector part 2 (i.e., here, the connector face part 24). In the example shown, the part and the mounting adapter 14 have compatible conical sections which facilitate an exact adjustment. Consequently, in production, the plug contacts 21A, 21B are then each screwed to the corresponding busbar 11A, 11B; see, in particular, the enlarged view in FIG. 15. This facilitates simple production. In addition, the typically mechanically highly-stressed plug contacts 21A, 21B can be easily replaced. The mounting adapter 14 is thus formed to fit to a part of the plug-in connector part 2. The mounting adapter 14 thus serves as an interface for mounting the pre-assembled module 1 on the plug-in connector part 2.

FIG. 16 shows how the mounting adapter 14 is fastened to the sleeve 10—specifically, to the opening 101 of the sleeve 10, and, in fact, by means of a latching connection. The mounting adapter 14 has a circumferential projection which engages in a circumferential groove of the sleeve 10.

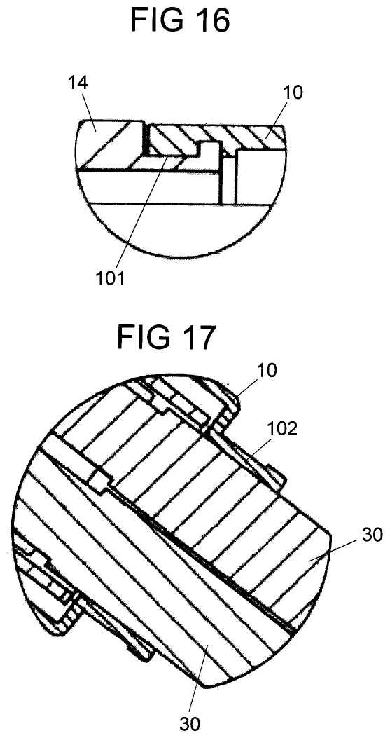

FIG. 17 shows the feedthrough section 102 of the sleeve 10 with the load lines 30 fed through. The feedthrough section 102 is designed in the form of a grommet (e.g., a rubber grommet) and adjoins the load lines 30 in sections.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Module
10 Sleeve
100 Interior space
101 Opening
102 Feedthrough section
11A, 11B Busbar
110 First section
111 Second section
112 Mounting section
113 Receptacle
12A-12D Heat capacity element
13 Insulating support
130 Separating section
131, 132 Transverse part
133 Screw dome
14 Mounting adapter
15A, 15B Housing part
16 Screw
17 First section
18 Second section
2 Plug-in connector part
20 Housing
200, 201 Housing part
202 Handle
21A, 21B Plug contact
22, 23 Plug-in section
24 Plug-in face part
3 Cable
30 Load line
4 Mating connector part
40 Counter-contact element
5 Vehicle
6 Charging station
E Insertion direction

What is claimed is:

1. A module for a plug-in connector part, comprising:
a sleeve;
at least two busbars, arranged in the sleeve, to each of which a plug contact and at least one load line are connectable or connected; and
at least one heat capacity element mounted in or on the sleeve,
wherein the module is mountable on the plug-in connector part.

2. The module of claim 1, wherein the at least one heat capacity element comprises a material having a specific heat capacity of above 0.5 kJ/(kg K).

3. The module of claim 1, wherein the at least one heat capacity element is mounted on one of the busbars of the at least two busbars by a housing part comprising an insulation material.

4. The module of claim 1, wherein the at least one heat capacity element lies flat against one of the busbars of the at least two busbars.

5. The module of claim 1, wherein the at least one heat capacity element comprises at least two heat capacity elements, between which the at least two busbars are arranged.

6. The module of claim 1, further comprising at least one interface configured to mount the module on the plug-in connector part by a mounting adapter, which the sleeve closes and which has an opening for each of the plug contacts.

7. The module of claim 1, wherein the at least two busbars are mounted on an insulating support arranged in the sleeve.

8. The module of claim 1, wherein each of the busbars of the at least two busbars has a larger cross-section than a cross-section of one at least one load line.

9. The module of claim 1, wherein the at least two busbars each have two sections which are at an angle to one another.

10. The module of claim 1, wherein the sleeve forms an interior space, and
wherein the interior space is sealed.

11. A plug-in connector part for connecting to a mating connector part, the plug-in connector part comprising:
a housing; and
at least one module of claim 1 arranged in the housing.

12. The plug-in connector part of claim 11, wherein the plug-in connector part comprises a vehicle charging plug.

13. A method for producing a plug-in connector part for connecting to a mating connector part, the method comprising:
assembling at least two busbars and at least one heat capacity element to form a module; and
mounting the module in a housing.

14. The module of claim 2, wherein the specific heat capacity is above 1.0 kJ/(kg K).

15. The module of claim 8, wherein each of the busbars of the at least two busbars has a cross-section that is at least twice as large as the cross-section of the one at least one load line.
